(19) United States
(12) Patent Application Publication
(10) Pub. No.: US 2008/0154734 A1
(43) Pub. Date: Jun. 26, 2008

(54) CONTACTLESS PAYMENT SELECTION CRITERIA BASED ON FINANCIAL ACCOUNT STATUS

(75) Inventors: Juan C. Fernandez, Boca Raton, FL (US); Eric T. Eaton, Lake Worth, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc., Schaumburg, IL (US)

(21) Appl. No.: 11/616,205

(22) Filed: Dec. 26, 2006

(51) Int. Cl. G06Q 20/00; G06Q 40/00

(52) U.S. Cl. 705/16; 705/39

(57) ABSTRACT

A method (300) of selecting a financial account to be used to make a contactless payment. The method can include, during a payment transaction at a point-of-sale terminal (110), selecting at least one financial account having associated financial information, the financial account selected from a plurality of available financial accounts. Contactless payment for the purchase can be made using the selected financial account. The method further can include identifying a type of purchase being made during the payment transaction. In such an arrangement, selecting the financial account can include selecting the financial account having associated financial information that best matches user preferences established for the identified type of purchase.

### BACKGROUND OF THE INVENTION

1. Field of the Invention

The present invention generally relates to mobile stations and, more particularly, to mobile stations that may be used to make contactless payments at point-of-sale terminals.

2. Background of the Invention

Mobile stations currently are being developed which may be used to make contactless payments at point-of-sale terminals. For example, when a consumer is at a check-out counter of a retail store, in lieu of swiping a credit card or paying with cash or check, the user will be able to pay for his merchandise using his mobile station. For instance, using near filed communication signals, the mobile station will be able to wirelessly communicate account information for one of the user's credit cards or debit cards to the point-of-sale terminal.

When the user stores information for multiple credit and debit cards on his mobile station, the user can select which credit/debit account is to be used for payment in the transaction. For example, the user can navigate through a series of menus provided on the display of the mobile station in order to make a credit/debit account selection. Navigating through such menus can be cumbersome, however. Moreover, the user may not immediately know which credit/debit account would be best to use for payment in the present transaction.

### SUMMARY OF THE INVENTION

The present invention relates to a method of selecting a financial account to be used to make a contactless payment. The method can include, during a payment transaction at a point-of-sale terminal, automatically selecting at least one financial account having associated financial information, the financial account selected from a plurality of available financial accounts. The financial account that is selected can be the financial account that best matches user preferences.

Contactless payment for the purchase can be made using the selected financial account. The method further can include identifying a type of purchase being made during the payment transaction. In such an arrangement, selecting the financial account can include selecting the financial account having associated financial information that best matches user preferences established for the identified type of purchase.

The method also can include receiving at least one user input to establish account selection criteria. In this arrangement, selecting the financial account can include comparing the financial information for at least one of the plurality of available financial accounts to the account selection criteria.

The method further can include receiving the financial information for at least one of the plurality of available financial accounts in response to the payment transaction being initiated. In another arrangement, the financial information for at least one of the plurality of available financial accounts can be received at a periodic interval. In yet another arrangement, the financial information can be received for at least one of the plurality of available financial accounts in response to a user request.

Selecting the financial account can include identifying at least one incentive in the financial information associated with at least one of the financial accounts, identifying an account balance or a credit limit in the financial information associated with at least one of the financial accounts, identifying an interest rate in the financial information associated with at least one of the financial accounts, and/or identifying an account type in the financial information associated with at least one of the financial accounts.

The method also can include presenting an indicator to a user indicating the financial account used to make the contactless payment. Further, an identifier for the financial account used to make the contactless payment and information associated with the payment transaction can be archived.

The present invention also relates to a method that includes, during a payment transaction at a point-of-sale terminal, automatically presenting to a user a plurality of available financial accounts having associated financial information, receiving a user selection of at least one of the financial accounts, and making the contactless payment for the transaction using the selected financial account.

The present invention also relates to a mobile station suitably configured to make a contactless payment at a point-of-sale terminal. The mobile station can include at least a first transceiver and a controller. The controller can, during a payment transaction at the point-of-sale terminal, select at least one financial account having associated financial information that best matches user preferences. The financial account can be selected from a plurality of available financial accounts. The controller also can communicate to the transceiver information to be communicated to the point-of-sale terminal in order to make the contactless payment for the transaction using the selected financial account. The controller further can identify a type of purchase being made during the payment transaction and select the financial account having associated financial information that best matches user preferences established for the identified type of purchase.

The mobile station further can include a user interface that receives at least one user input to establish account selection criteria. In such an arrangement, the controller can compare the financial information for at least one of the plurality of available financial accounts to the account selection criteria in order to select the financial account.

In one arrangement, the controller can receive the financial information for at least one of the plurality of available financial accounts in response to the payment transaction being initiated. In another arrangement, the controller can receive the financial information for at least one of the plurality of available financial accounts at a periodic interval. In yet another arrangement, the controller can receive the financial information for at least one of the plurality of available financial accounts in response to a user request.

The controller also can identify at least one incentive in the financial information associated with at least one of the financial accounts in order to select the financial account. The controller also can identify an account balance, a credit limit or an interest rate in the financial information associated with at least one of the financial accounts in order to select the financial account. Further, the controller can identify an account type in the financial information associated with at least one of the financial accounts in order to select the financial account.

The mobile station also can include a user interface that presents an indicator to a user indicating the financial account used to make the contactless payment. In addition, the mobile station also can include a data storage on which an identifier for the financial account used to make the contactless payment and information associated with the payment transaction are archived.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a mobile station that is useful for understanding the present invention; and

FIG. 3 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for selecting a financial account to be used when making a contactless payment at a point-of-sale terminal. During the payment transaction, financial information for each of a plurality of available financial accounts can be processed to identify a financial account that is best suited to make payment for the purchase. The financial information can include account types (e.g. credit or debit), outstanding account balances, credit limits, purchase incentives, interest rates, payment due dates, or any other information that can be processed to influence a financial account selection.

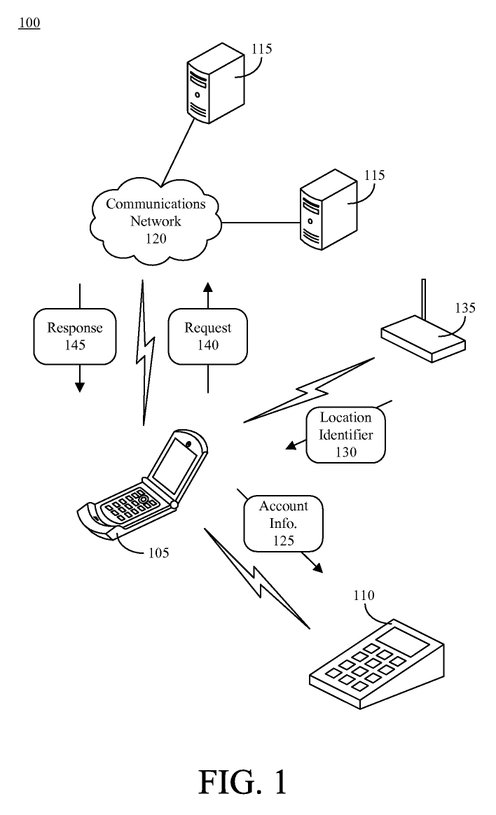

FIG. 1 depicts a communications system 100 that is useful for understanding the present invention. The communications system 100 can include a mobile station 105. The mobile station 105 can be a mobile telephone, a mobile radio, a personal digital assistant, a mobile computer, or any other suitably configured wireless communication device. The mobile station 105 can communicate with a point-of-sale terminal 110 in order to make payments in financial transactions.

In one arrangement, the mobile station 105 can wirelessly communicate with the point-of-sale terminal 110 to make contactless payments. As used herein, the term “contactless payment” means a payment transaction in which the mobile station 105 need not physically contact the point-of-sale terminal 110 in order to communicate financial account information. For example, the mobile station 105 can communicate with the point-of-sale terminal 110 in accordance with IEEE 802.11, a near field communication protocol, such as Bluetooth or ZigBee, infrared signaling, or any other suitable wireless communications protocol.

In another arrangement, the mobile station 105 can communicate with the point-of-sale terminal 110 via a wired communications port, for instance via a universal serial bus (USB) port or an IEEE-1394 port. Still, the mobile station can communicate with the point-of-sale terminal 110 in any other suitable manner and the invention is not limited in this regard.

The point-of-sale terminal 110 can be a stationary or portable device. For instance, in a grocery store the point-of-sale terminal 110 can be located at a check-out counter. In a restaurant, the point-of-sale terminal 110 can be presented to a user at the user's table for payment processing. Still, the point-of-sale terminal 110 can be implemented in any other suitable manner and the invention is not limited in this regard. The point-of-sale 110 terminal can comprise one or more communications adapters suitable for communicating with the mobile station 105 and/or communicating with a server for credit authorizations. For instance the point-of-sale terminal 110 can include one or more suitable communications ports, infrared ports, wireless transceivers, communications modems, or the like.

The mobile station 105 can be configured to communicate with one or more network nodes 115 via a communications network 120. The network nodes 115 can be web servers, network servers, local area network servers, or any other network nodes which can communicate information to the mobile station 105 via the communications network 120. The communications network 120 can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network 120 can include wired and/or wireless communication links. Suitable security protocols can be implemented by the network node 115, the communications network 120 and/or the mobile station 105 to protect against unauthorized access to the information being communicated.

In operation, a financial account to be used to make a contactless payment at the point-of-sale terminal 110 can be automatically selected. For example, financial information from each of a plurality of available financial accounts can be processed and, based upon the financial information, a suitable financial account can be selected. In addition to the financial information, the type of purchase also can be identified and processed as part of the financial account selection process. Once the financial account has been selected, account information 125 can be communicated from the mobile station 105 to the point-of-sale terminal 110 to complete the financial transaction.

In one aspect of the invention, selection of the financial account also can be based, at least in part, on user preferences. The user preferences can, for instance, indicate to select a financial account having the greatest amount of available credit or a lowest account balance. In another example, the user preferences can indicate to select a financial account offering the lowest interest rate, the greatest incentives or the most desirable payment structure. Still, the financial account used to make payment for the financial transaction can be selected in any other suitable manner and the invention is not limited in this regard.

In illustration, the user preferences can identify a plurality of credit card accounts that are to be used for a certain type of transaction, for instance to purchase gasoline. When a gasoline purchase transaction is initiated, the financial information associated with the identified accounts can be processed to select the account which best meets the user's preferences. For example, if the user preferences indicate that the user wants to use the credit account having the lowest interest rate, the interest rates offered by the identified credit card accounts can be compared and the credit card account offering the lowest interest rate can be selected. The selected account then can be used to make payment for the gasoline purchase.

Oftentimes purchase incentives can vary depending on the type of financial transaction and/or where the financial transaction takes place. For example, a first credit account may offer one reward point for every monetary unit spent using the credit account. Further, the first credit account may double the reward points for grocery purchases. A second credit account having a lower interest rate than the first credit account also may offer one reward point for each monetary unit spent, but may not double the reward points. Thus, if user preferences indicate the user wishes to maximize reward points, the first credit account can be automatically selected for grocery purchases. However, since both credit accounts may offer equivalent reward points for non-grocery purchases and the second credit account offers a lower interest rate, the second credit account can be automatically selected for non-grocery purchases.

In another example, the user preferences can indicate to use a credit account having the lowest interest rate for all transactions over a threshold monetary amount. For transactions under the threshold amount, the user preferences can indicate to select a credit or debit account based on the type of transaction. For instance, assuming the transactions do not exceed the threshold amount, a first debit account can be automatically selected to purchase groceries, a second credit account can be automatically selected to purchase household items, and a third credit account can be automatically selected to pay for automobile repairs. If, however, a particular automobile repair costs more than the threshold amount and the second credit account offers the lowest interest rate, the second credit account may be automatically selected to pay for the automobile repair. Similarly, the second credit account can be automatically selected to pay for groceries should the grocery purchase transaction exceed the threshold amount.

A location identifier 130 can be processed by the mobile station 105 to determine where a financial transaction is taking place and/or to indicate the type of transaction. For example, the location identifier 130 can indicate a business name, a type of business, a type of product or service that is the subject of the financial transaction, a specific product or service that is the subject of the financial transaction, or any other indicator that may be location dependent.

The location identifier 130 can be transmitted by a beacon or transponder 135 at a specific location or generated by the point-of-sale terminal 110. In such an arrangement the location identifier 130 can be received wirelessly by the mobile station 105. In another arrangement, the location identifier 130 can be manually entered into the mobile station 105. Still, the location identifier 130 can be generated in any suitable manner and received by the mobile station 105 in any suitable manner and the invention is not limited in this regard.

In one arrangement, the selection of the financial account can be performed on the mobile station 105. In such an arrangement, the mobile station 105 can communicate a request 140 to one or more of the network nodes 115 requesting financial information related to each of the financial accounts that are available to make payment in the financial transaction. The request 140 can be sent by the mobile station 105 in response to a payment transaction being initiated or in response to a user request. Alternatively, the request 140 can be periodically sent to the network nodes 115 at a defined interval. The interval can be defined by seconds, minutes, hours, days and/or weeks.

The network nodes 115 can respond to the request 140 with a response 145 that is communicated to the mobile station 105. The response 145 can comprise the requested financial information which, as noted, can include account types, outstanding account balances, credit limits, interest rates on new purchases, interest rates on balance transfers, payment due dates, purchase incentives (e.g. cash rewards, points, point multipliers, special incentives, and the like) or any other information that may influence selection of the financial account to be used to make payment in the financial transaction. The mobile station 105 can process the financial information and select the financial account to use for payment in the financial transaction.

In another arrangement, the selection of the financial account can be performed at a network node 115, in which case the user preferences can be stored on the network node 115 or transferred to the network node when required. In such an arrangement, the response 145 can comprise an indicator identifying the selected account to be used for the financial transaction. If information for available financial accounts is maintained on the mobile station 105, the indicator can be processed on the mobile station 105 to identify and retrieve the account information 125 that is communicated to the point-of-sale terminal 110. In another aspect of the invention, the response 145 can comprise the account information 125. Thus, the mobile station 105 can merely forward to the point-of-sale terminal 110 the account information that is received from the network node 115.

Regardless of where the financial account selection takes place, after such selection and indicator of the selected financial account can be presented to the user, for instance via a user interface of the mobile station 105 or of the point-of-sale terminal 110. Further, an identifier for the financial account used to make the contactless payment and other information pertaining to the financial transaction can be archived, for instance on the mobile station 105 or at a network node 115. Such other information can include an identifier associated with the point-of-sale terminal 110, a name of an establishment where the financial transaction took place (e.g. the location identifier 130), items purchased, serial and/or model numbers of the items purchased, time and date of the financial transaction, and/or any other information that may be relevant to the financial transaction.

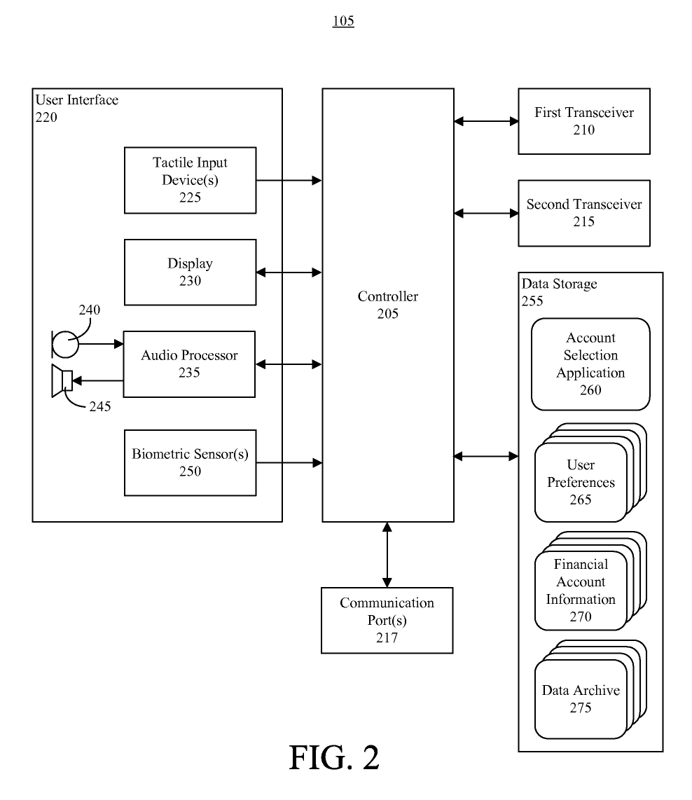

FIG. 2 depicts an example of the mobile station 105 that is useful for understanding the present invention. The mobile station 105 can include a controller 205. The controller 205 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The mobile station 105 also can include a first transceiver 210. The first transceiver 210 can modulate and demodulate signals to convert signals from one form to another, and can transmit and/or receive such signals over one or more various wireless communication networks. In illustration, the first transceiver 210 can be configured to communicate data via IEEE 802 wireless communications, for example, 802.11 and 802.16 (WiMax), WPA, or WPA2. In another example, the transceiver 210 can communicate data via GSM, TDMA, CDMA, WCDMA, OFDM, or direct wireless communication. Further, the transceiver 210 also can be configured to communicate over a wireless communication link using any of a myriad of communications protocols, for example, TCP/IP.

The first transceiver 210 can receive responses that include financial account identifiers and/or financial account information from one or more network nodes. The first transceiver 210 also can receive identifiers from beacons, transponders, and the like. The first transceiver 210 can communicate received information and/or identifiers to the controller 205, or any other suitable mobile station components. The first transceiver 210 also can receive requests, and/or other information from the controller 205 (or other suitable mobile station components) and communicate such information via a communications network. For example, the first transceiver 210 can communicate requests to one or more network nodes, as described with reference to FIG. 1 and throughout the specification.

The mobile station 105 also can include a second transceiver 215. The second transceiver 215 also can modulate and demodulate signals to convert signals from one form to another. In one arrangement, the second transceiver 215 can be configured to communicate using near field communications. For example, the second transceiver 215 can communicate using Bluetooth, ZigBee or an infrared communications protocol. In another arrangement, the second transceiver 215 can communicate via IEEE 802 wireless communications, WPA, WPA2, GSM, TDMA, CDMA, WCDMA or OFDM. Fewer or additional transceivers can be included within the mobile station 105. As such, the particular number of transceivers included within the mobile station 105 and/or the particular communication protocols used are not intended to limit the present invention.

The second transceiver 215 can exchange financial transaction information with point-of-sale terminals, as well as receive identifiers from beacons, transponders, and the like. The second transceiver 215 can communicate the identifiers, information received from point-of-sale terminals, and/or other received information to the controller 205. Alternatively, such information can be communicated to any other suitable mobile station components. The second transceiver 215 also can communicate information to other devices. For instance, the second transceiver 215 can communicate account information to point-of-sale terminals.

In an alternate arrangement, in lieu of, or in addition to the second transceiver 215, the mobile station 105 can include one or more communications ports 217 used by the mobile station 105 to exchange information with other devices. For example, the communications ports 217 can communicate the identifiers, information received from point-of-sale terminals, and/or other received information to the controller 205. The communications ports 217 also can communicate information from the controller 205 and/or other mobile station components to such other devices. The communications ports 217 can include, for instance, a universal serial bus (USB) port, an IEEE-1394 port, and/or any other suitable communications port(s).

The mobile station 105 also can include a user interface 220 comprising one or more tactile input devices 225 and a display 230. The tactile input devices 225 can comprise one or more buttons, keys, soft keys, sensors, or any other devices suitable for receiving a tactile user input. The display 230 can be a liquid crystal display (LCD), a liquid crystal on silicon (LCOS) display, a cathode ray tube (CRT), a plasma display, or any other suitable display. In one arrangement, the display 230 can comprise a touch screen that can receive tactile and/or stylus inputs and communicate such inputs to the controller 205. The tactile input devices 225 and/or display 230 can receive user inputs to enter user preferences, to initiate requests communicated over the communications network, or perform any other suitable mobile station functions.

The user interface 220 further can include an audio processor 235 connected to an input audio transducer 240 (e.g. microphone) and an output audio transducer 245 (e.g. loudspeaker). The audio processor 235 can be integrated with the controller 205 or provided as a separate component that is communicatively linked to the controller 205. The audio processor 235 can comprise a CPU, a DSP, an ASIC, a PLD, a plurality of discrete components that cooperate to process audio data, and/or any other suitable audio processing device. The audio processor 235 can receive input audio signals from the input audio transducer 240 and communicate such signals to the controller 205. Similarly, the audio processor can receive output audio signals from the controller 205 and communicate such signals to the output audio transducer 245. In one arrangement, the controller 205 can process audio signals received from the audio processor 235 to receive user preferences, to initiate requests communicated over the communications network, or perform any other suitable mobile station functions.

The mobile station 105 further can include data storage 255. The data storage 255 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 255 can be integrated into the controller 205, though this need not be the case.

An account selection application 260 and user preferences 265 can be contained on the data storage 255. In addition, financial account information 270 received from another network node and archived data 275 can be contained on the data storage 255. The financial account information can be updated in response to a payment transaction being initiated, in response to a user request, or at a defined interval. The archived data 275 can include identifiers for financial accounts used to make contactless payments and information associated with the payment transactions.

The controller 205 can execute the account selection application 260 to implement the processes and methods described herein. For example, during a financial transaction the account selection application 260 can be executed to select a financial account 270 that is to be used to make payment. The controller 205 also can execute the account selection application 260 to communicate information for the selected account to the second transceiver 215, which can transmit the information to a point-of-sale terminal in order to make a payment using the selected financial account. Further, the controller 205 can present, via the user interface 220, information to a user, for instance messages to prompt the user to enter preferences or user selections, information pertaining to a financial account used to make a contactless payment, and information associated with the payment transaction. The controller 205 also can store the user preferences and information to the data storage 255.

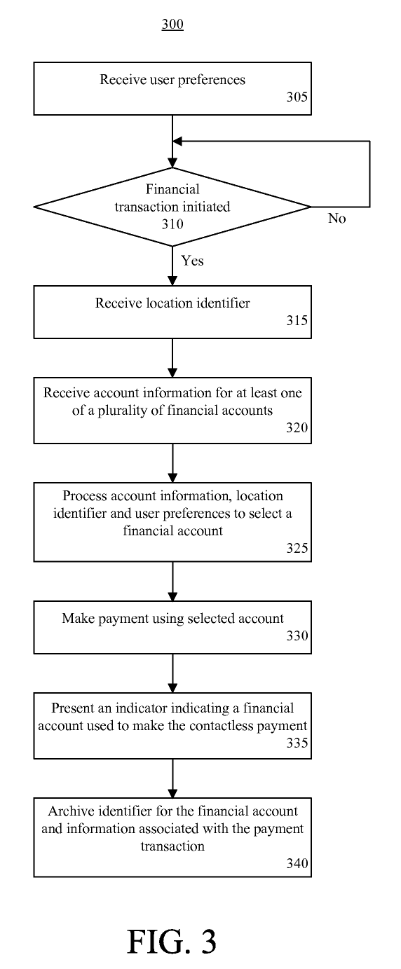

FIG. 3 is a flowchart presenting a method 300 that is useful for understanding the present invention. The method 300 can begin in a state in which a mobile station has been configured to receive financial account information and to make contactless payments at point-of-sale terminals. At step 305 user preferences can be received. The user preferences can be received on the mobile station and stored on the mobile station, or transferred to another network node, for instance a server. In another arrangement, the user preferences can be received by the network node via alternative means, for instance via the Internet.

Referring to decision box 310, the mobile station can monitor for a financial transaction to be initiated between the mobile station and a point-of-sale terminal. In response to a financial transaction being initiated, at step 315 a location identifier can be received. As noted, the location identifier can indicate where a financial transaction is taking place and/or to indicate the type of transaction.

Proceeding to step 320, account information for each of a plurality of financial accounts can be received on a device tasked with automatically selecting a financial account to use to make payment in the financial transaction. Such device can be the mobile station or another network node with which the mobile station can be communicatively linked. As noted, the financial information can include account types, outstanding account balances, credit limits, purchase incentives, interest rates, payment due dates, or any other information that can be processed to influence a financial account selection.

At step 325, the account information and user preferences can be processed to select a credit account to use to make payment in the financial transaction. Optionally, the location identifier also can be processed to make the selection. If the selection is performed by a network node other than the mobile station, an identifier and/or other information for the financial account can be communicated to the mobile station. At step 330, the account information can be wirelessly communicated to a point-of-sale terminal to make payment using the selected account.

Proceeding to step 335, an indicator that indicates a financial account used to make the contactless payment can be presented to the user. At step 340, the identifier associated with the financial account and other information associated with the payment transaction can be archived.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method of selecting a financial account to be used to make a contactless payment, comprising:
during a payment transaction at a point-of-sale terminal, automatically selecting at least one financial account having associated financial information, the financial account selected from a plurality of available financial accounts; and
making the contactless payment for the transaction using the selected financial account.

2. The method of claim 1, wherein automatically selecting the financial account comprises automatically selecting the financial account that best matches user preferences.

3. The method of claim 1, further comprising:
identifying a type of purchase being made during the payment transaction;
wherein automatically selecting the financial account comprises selecting the financial account having associated financial information that best matches user preferences established for the identified type of purchase.

4. The method of claim 1, further comprising:
receiving at least one user input to establish account selection criteria;
wherein automatically selecting the financial account comprises comparing the financial information for at least one of the plurality of available financial accounts to the account selection criteria.

5. The method of claim 1, further comprising receiving the financial information for at least one of the plurality of available financial accounts in response to the payment transaction being initiated, in response to a user request or at a periodic interval.

6. The method of claim 1, wherein automatically selecting the financial account comprises identifying at least one incentive in the financial information associated with at least one of the financial accounts.

7. The method of claim 1, wherein automatically selecting the financial account comprises identifying an account balance or a credit limit in the financial information associated with at least one of the financial accounts.

8. The method of claim 1, wherein automatically selecting the financial account comprises identifying an interest rate in the financial information associated with at least one of the financial accounts.

9. The method of claim 1, wherein automatically selecting the financial account comprises identifying an account type in the financial information associated with at least one of the financial accounts.

10. The method of claim 1, further comprising presenting an indicator to a user indicating the financial account used to make the contactless payment.

11. The method of claim 1, further comprising:
archiving an identifier for the financial account used to make the contactless payment; and
archiving information associated with the payment transaction.

12. A method of selecting a financial account to be used to make a contactless payment, comprising:
during a payment transaction at a point-of-sale terminal, automatically presenting to a user a plurality of available financial accounts having associated financial information;
receiving a user selection of at least one of the financial accounts; and
making the contactless payment for the transaction using the selected financial account.

13. A mobile station suitably configured to make a contactless payment, comprising:
at least a first transceiver; and
a controller that, during a payment transaction at a point-of-sale terminal, selects at least one financial account having associated financial information, the financial account selected from a plurality of available financial accounts, the controller also communicating to the transceiver information to be communicated to the point-of-sale terminal in order to make the contactless payment for the transaction using the selected financial account.

14. The mobile station of claim 13, wherein the financial account that is selected is a financial account that best matches user preferences.

15. The mobile station of claim 13, wherein the controller further identifies a type of purchase being made during the payment transaction and selects the financial account having associated financial information that best matches user preferences established for the identified type of purchase.

16. The mobile station of claim 13, further comprising:
a user interface that receives at least one user input to establish account selection criteria;
wherein the controller compares the financial information for at least one of the plurality of available financial accounts to the account selection criteria in order to select the financial account.

17. The mobile station of claim 13, wherein, in order to select the financial account, the controller identifies at least one incentive, an account balance, a credit limit, an account type or an interest rate in the financial information associated with at least one of the financial accounts.

18. The mobile station of claim 13, wherein the controller receives the financial information for at least one of the plurality of available financial accounts in response to the payment transaction being initiated, in response to a user request or at a periodic interval.

19. The mobile station of claim 13, further comprising a user interface that presents an indicator to a user indicating the financial account used to make the contactless payment.

20. The mobile station of claim 13, further comprising a data storage on which an identifier for the financial account used to make the contactless payment and information associated with the payment transaction are archived.
